(19) United States
(12) Patent Application Publication
(10) Pub. No.: US 2025/0290208 A1
(43) Pub. Date: Sep. 18, 2025

(54) HYDROGEN AND OXYGEN GAS GENERATION DEVICE

(71) Applicant: W J CERVENY DESIGN LLC, Watonga, OK (US)

(72) Inventor: William J. Cerveny, Glendale, AZ (US)

(21) Appl. No.: 19/081,073

(22) Filed: Mar. 17, 2025

Related U.S. Application Data
(60) Provisional application No. 63/565,948, filed on Mar. 15, 2024.

(51) Int. Cl. C25B 1/04; C25B 9/17; C25B 9/60; C25B 13/08

(52) U.S. Cl. CPC C25B 1/04; C25B 9/17; C25B 9/60; C25B 13/08

(57) ABSTRACT

A hydrogen and oxygen gas generation system is provided. The system includes a vessel containing a volume of water and a plurality of electrically conductive electrodes positioned in the volume of water. An ultrasonic unit is positioned in the volume of water and configured to emit sonic waves that inject pulsed energy into the water. The ultrasonic unit can emit square waves and vary both frequency and timing to create complex wave patterns. A baffle structure is positioned between the plurality of electrodes and the ultrasonic unit. The baffle structure prevents direct vertical impact of sonic waves on the electrodes while allowing waves to assist in weakening molecular bonds in the water. The system includes a gas collection unit with separate chambers for collecting hydrogen gas from cathodes and oxygen gas from anodes.

### CROSS-REFERENCE TO RELATED APPLICATIONS

This application claims the benefit of U.S. Provisional Application No. 63/565,948, filed on Mar. 15, 2024. The entire disclosure of the above application is incorporated herein by reference.

### FIELD

The present technology relates to methods and apparatus for separating water into hydrogen and oxygen gases using electrolysis, and, more particularly, to systems utilizing ultrasonic waves in combination with electrical current to drive the separation of water molecules.

### INTRODUCTION

This section provides background information related to the present disclosure which is not necessarily prior art.

The separation of water into hydrogen and oxygen gases through electrolysis can provide a source of clean fuel for various applications, including internal combustion engines. Electrolysis techniques can employ a vessel containing water with one or more electrolysis units configured to provide electrical current through the water to release hydrogen and oxygen gases. Hydrogen as a fuel source can provide reduced and carbonless emissions. Electrolysis systems face certain challenges, however, in generating hydrogen and oxygen gases at economically feasible costs. Electrolysis requires significant electrical energy input and can be cost-prohibitive compared to traditional fossil fuels.

Certain electrolysis systems incorporate ultrasonic wave generation during the electrolysis process in an attempt to improve efficiency. These systems use ultrasonic waves to inject pulsed energy into the water, which can weaken molecular bonds and promote the breakdown of water molecules into hydrogen and oxygen gases. Direct application of ultrasonic waves in electrolysis systems, however, can interfere with the formation of gases at the electrode surfaces, reducing overall system efficiency.

Certain designs for in-vehicle hydrogen generation face additional challenges related to the storage and on-demand production of hydrogen gas. Such systems often require the addition of electrolytes or other additives to the water to enhance conductivity, adding complexity and cost to the process. What is more, in-vehicle hydrogen generation systems have struggled to achieve sufficient hydrogen production rates to be practical for widespread vehicular applications.

There is a continuing need for an improved hydrogen and oxygen gas generation system that can operate more efficiently and cost-effectively than certain electrolysis units. Desirably, such a system would enhance the production rate of hydrogen and oxygen gases without requiring electrolyte additives, while effectively managing the interaction between ultrasonic waves and electrode surfaces to optimize gas generation efficiency.

### SUMMARY

In concordance with the instant disclosure, an improved hydrogen and oxygen gas generation system has surprisingly been discovered. The present technology includes articles of manufacture, systems, and processes that relate to the separation of water into hydrogen and oxygen gases using electrolysis with ultrasonic wave generation and baffle structures to enhance gas production efficiency.

In certain embodiments, a hydrogen and oxygen gas generation system can include a vessel containing a volume of water. A plurality of electrically conductive electrodes can be positioned within the volume of water in the vessel. An ultrasonic unit can be positioned in the volume of water and configured to emit sonic waves that inject pulsed energy into the water to weaken molecular bonds. A baffle structure can be positioned between the plurality of electrodes and the ultrasonic unit to prevent direct vertical impact of sonic waves on the electrodes while allowing the waves to assist in weakening molecular bonds.

In certain embodiments, a method of generating hydrogen and oxygen gases can include providing a vessel containing a volume of water. The method can include positioning a plurality of electrically conductive electrodes in the volume of water and positioning an ultrasonic unit in the volume of water. A baffle structure can be positioned between the electrodes and the ultrasonic unit. Electrical current can be applied to the electrodes to create an electrochemical gradient in the water that polarizes the water molecules and puts stress on molecular bonds. The ultrasonic unit can emit sonic waves into the water while electrical current is applied, causing the water molecules to resonate and creating additional stress on molecular bonds. As the water molecules break down under this combined stress, hydrogen gas can be collected at the cathodes and oxygen gas can be collected at the anodes of the electrodes.

In certain embodiments, a hydrogen and oxygen gas generation system includes a vessel containing a volume of water, a plurality of electrodes forming portions of electrolysis units, an ultrasonic unit, a baffle structure and a source of electrical current. The vessel can have any desired size and shape and can be configured with any desired volume of water. The volume of water constitutes tap water, without added electrolytes, such as a salt or other additives. Each electrode of the plurality of electrodes cam be configured to receive and convey electrical current to the volume of water as is known in the art. The ultrasonic unit is configured to inject pulsed energy into the volume of water, thereby weakening the molecular bonds in the water molecules and further promoting a breakdown of the water molecules into hydrogen and oxygen gases.

The baffle structure is positioned between the plurality of electrodes and the ultrasonic unit. The baffle structure functions to prevent against the sonic waves from hitting each of the plurality of electrodes and disrupting the formation of hydrogen and oxygen gases on each of the plurality of electrodes. Rather than disrupting the formation of hydrogen and oxygen gases at the sites of the plurality of electrodes, the baffle structure facilitates the weakening of the molecular bond of the volume of water, thus allowing for improved hydrogen and oxygen gas generation. In this manner, the baffle structure can therefore enhance the efficiency of hydrogen and oxygen gas production, making the technology more viable for certain applications, such as the non-limiting example of in-vehicle combustion engine applications. The baffle structure is configured to facilitate the effective transmission of ultrasonic energy from the ultrasonic unit while militating against direct impact of the ultrasonic energy on each of the plurality of electrodes.

In certain embodiments, the material forming the baffle structure could possess certain properties. The material could have an acoustic impedance that is compatible with water to ensure efficient transmission of ultrasonic waves. Given the environment, the material could be resistant to water and other chemicals it may come into contact with during the hydrogen and oxygen gas generation process. The material could maintain its structural integrity and performance characteristics over a wide range of operating conditions, including temperature variations and continuous ultrasonic vibration. The material could be chemically inert with water, or the gases produced during electrolysis. In some embodiments, the hydrogen and oxygen gas generation system can include a hydrogen detection sensor. In some embodiments, the hydrogen and oxygen gas generation system may include a safety gauge to release pressure as needed.

In certain embodiments, the baffle structure can include one or more mechanisms, structures, and/or devices configured to increase and/or decrease ultrasonic wave motion. Examples of such baffle structures can include rubber sheeting, a rubber piece of material, or other similar devices known to those of skill in the art to be capable of increasing/disrupting the ultrasonic wave patterns.

In operation a volume of water is contained in the vessel. The plurality of electrodes is positioned in the volume of water and an electrical current is applied to the plurality of electrodes. The electrical current polarizes the water molecules and puts stress on the molecular bonds. At the same time, the ultrasonic unit pulses the water at a frequency that causes the molecules to resonate. This puts additional stress on the molecular bonds. The ultrasonic waves can have the form of square waves, which further stresses the molecules. This stress causes the water molecules to distend under the influence of the electrical polar forces. Eventually, the water molecule bonds break apart and hydrogen and oxygen in the water dissociate into hydrogen and oxygen cases, hydrogen collecting at certain electrodes and oxygen collecting at the other electrodes. Finally, the separated hydrogen and oxygen gases are collected and fed via separate conduit lines for downstream operations and/or purposes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic diagram of a system with a vessel containing water, electrodes, an ultrasonic unit, a baffle structure, and a gas collection unit with chambers.

FIG. 2 shows multiple systems sharing centralized power, water supply, and gas collection.

FIG. 3 shows a single large vessel with multiple ultrasonic units, electrode pairs, and baffle structure.

FIG. 4 shows a flow diagram of a method for generating hydrogen and oxygen gases.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

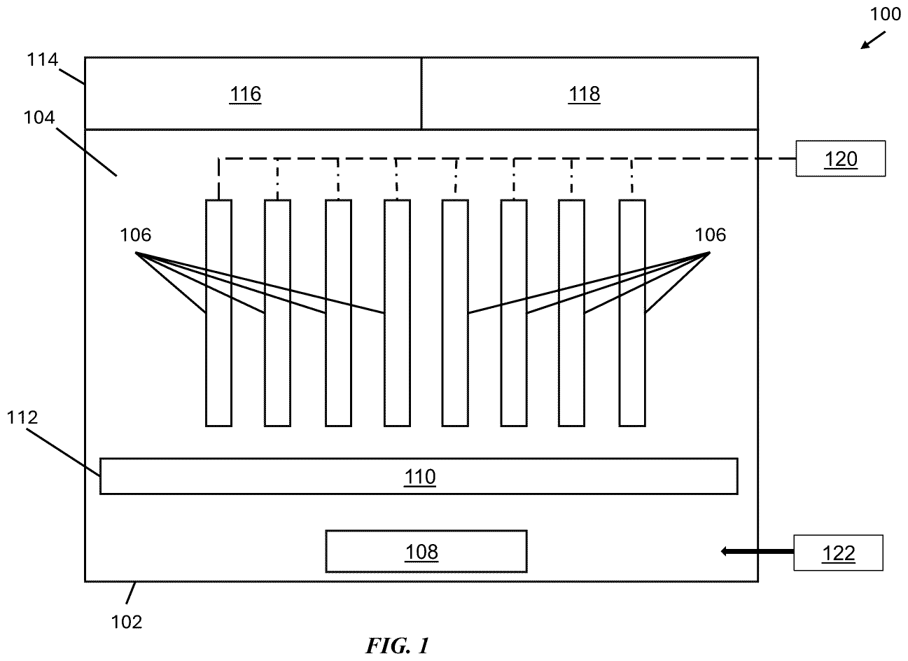

With reference to FIG. 1, a hydrogen and oxygen gas generation system 100 is shown. The hydrogen and oxygen gas generation system 100 utilizes electrolysis, which is a process where electrical current is applied directly to water to initiate the separation of water molecules into hydrogen gas and oxygen gas. When direct current is applied to the water through the electrodes, the water molecules are polarized, which puts stress on the molecular bonds. The water molecules eventually break down as the electrical current creates an electrochemical gradient that drives the positively charged hydrogen ions (protons) toward the cathode and the negatively charged oxygen ions toward the anode, where they combine to form their respective diatomic gases.

The hydrogen and oxygen gas generation system 100 can include a vessel 102 containing a volume of water 104, a plurality of electrodes 106, an ultrasonic unit 108, and a baffle structure 110. The vessel 102 serves as the container in which the electrolysis process occurs, housing the electrodes 106, the ultrasonic unit 108, and the baffle structure 110 that enable the generation of hydrogen and oxygen gases. The vessel 102 can have any desired size and shape and can be configured with any desired volume of water 104. Advantageously, the hydrogen and oxygen gas generation system 100 can operate using tap water without requiring electrolytes or other additives to enhance conductivity.

The size and shape of the vessel 102 can be selected based on the intended application and operating requirements of the hydrogen and oxygen gas generation system 100. The vessel 102 can be constructed to withstand the operating conditions of the electrolysis process, including exposure to water and generated gases, as well as the continuous vibrations from the ultrasonic unit 108. Additionally, the vessel 102 dimensions can allow for proper positioning of the baffle structure 110 between the ultrasonic unit 108 and electrodes 106 with adequate clearance, such as a one-inch clearance around the perimeter of the baffle structure 110, as an example.

The hydrogen and oxygen gas generation system 100 can include a plurality of electrodes 106 that are configured to receive and convey electrical current to the volume of water 104. The electrodes 106 can be constructed as straight or blade electrodes. The plurality of electrodes 106 can be fabricated from stainless steel. In one example, the electrodes 106 can include 304 stainless steel.

The number and placement of electrodes 106 can be selected based on several operational factors. The electrodes 106 can be positioned within the vessel 102 to allow proper interaction with both the electrical current and ultrasonic waves while maintaining separation between cathodes and anodes to enable effective gas collection. The spacing and arrangement of the electrodes 106 can be configured to work with the baffle structure 110, which can militate against ultrasonic waves from directly impacting the electrode surfaces, as described in greater detail herein. The number of electrodes 106 can be selected based on the volume of water 104 in the vessel 102 to enable effective gas collection and create an appropriate electrochemical gradient.

During operation, the electrodes 106 receive and convey electrical current to the volume of water 104. This electrical current polarizes the water molecules and puts stress on the molecular bonds. The electrodes 106 can function as sites where the hydrogen and oxygen gases collect after molecular dissociation. When electrical current is applied, hydrogen collects at certain electrodes while oxygen collects at other electrodes. More specifically, the electrodes 106 can include both cathodes (negatively charged electrodes) and anodes (positively charged electrodes). The polarity of the electrical current can determine which electrodes 106 serve as cathodes and which serve as anodes. The cathodes and anodes can create an electrochemical gradient in the volume of water 104 that polarizes the water molecules and puts stress on the molecular bonds. As the water molecules break down, the hydrogen gas collects at the cathodes while oxygen gas collects at the anodes.

The ultrasonic unit 108 is configured to inject pulsed energy into the volume of water 104, thereby weakening the molecular bonds in the water molecules and further promoting a breakdown of the water molecules into hydrogen and oxygen gases. The ultrasonic unit 108 can be positioned in the vessel 102 in the volume of water 104 with a capacity configured to enable effective transmission of the waves through the volume of water 104. During operation, the ultrasonic unit 108 can pulse the water at frequencies that cause the molecules to resonate. When direct current is applied through the electrodes 106 to polarize the water molecules and put stress on molecular bonds, the ultrasonic unit 108 can simultaneously apply pulsed sound waves. This combined electrolysis and pulsed sound wave approach can result in rapid breakdown of the molecules into hydrogen and oxygen gases. In one example, the ultrasonic waves can be emitted specifically in the form of square waves, which can create enhanced stress on the water molecules. The square wave configuration can cause the molecules to distend further under the influence of the electrical polar forces. A skilled artisan can select other suitable wave types within the scope of the present disclosure.

The ultrasonic unit 108 can be configured to vary the frequency of the emitted waves during operation in several ways. The wave frequency can be adjusted to create different resonance patterns in the water molecules. For example, the frequency can be increased or decreased over time to produce varying levels of molecular stress. The timing of wave emission can also be varied independently. The ultrasonic unit 108 can be configured to emit waves in intermittent pulses, with adjustable durations between pulses. The timing variation can include changes in the pulse length, pulse spacing, or overall pulse patterns. Additionally, the ultrasonic unit 108 can be configured to simultaneously vary both the wave frequency and emission timing. This combined variation can create complex wave patterns that can produce different levels of molecular stress on the water molecules. For instance, the unit can emit high-frequency waves in short pulses followed by lower-frequency waves in longer pulses. These varying wave patterns can work in conjunction with the electrical current from the electrodes 106 to enhance the breakdown of water molecules. When direct current is applied to polarize the water molecules and put stress on molecular bonds, the varying ultrasonic waves can simultaneously create additional resonance effects that can promote molecular dissociation.

The baffle structure 110 can be positioned between the plurality of electrodes 106 and the ultrasonic unit 108. The baffle structure 110 can be configured to militate against sonic waves from the ultrasonic unit 108 from directly hitting each of the plurality of electrodes 106 and disrupting the formation of hydrogen and oxygen gases. Without the baffle structure 110, ultrasonic waves can have a vertical motion through the water and can directly strike the electrodes 106. This direct vertical impact can disrupt the formation and collection of hydrogen and oxygen gas bubbles at the electrode surfaces, interfering with the gas generation process.

The baffle structure 110 can be configured to redirect the ultrasonic waves to facilitate improved hydrogen and oxygen gas generation. Rather than disrupting gas formation at the electrode sites, the baffle structure 110 can facilitate the weakening of molecular bonds in the volume of water 104 through controlled redirection of ultrasonic waves. The baffle 110 can thereby enable the ultrasonic waves to assist in molecular bond weakening while militating against direct disruption of gas formation at the electrode surfaces. By allowing the molecules to maintain their separation for a longer duration, the overall gas generation process can be improved.

The dimensions of the baffle structure 110 can be selected based on the volume of water 104 contained within the vessel 102. The baffle structure 110 can be sized to effectively redirect ultrasonic waves while maintaining proper clearance for wave propagation through the volume of water 104. In certain embodiments, the baffle structure 110 can generally correspond to the shape and dimensions of the vessel 102. More specifically, the baffle structure 110 can have an outer perimeter 112 that substantially corresponds to a perimeter of the vessel 102.

The baffle structure 110 can include a specific clearance around the outer perimeter 112 to enable ultrasonic waves to bounce around the volume of water 104. For example, the baffle structure 110 can be configured with a 1 inch clearance around the perimeter. The clearance around the outer perimeter 112 can allow the ultrasonic waves to be redirected from the normal vertical motion, causing them to bounce around the outer perimeter of the baffle structure 110 and the vessel 102 and impact the electrodes 106 from the side. While being bound to any particular theory, it is believed that the side impact enabled by the clearance between the baffle 110 and the vessel can allow hydrogen and oxygen molecules to separate for a longer period of time, thereby producing hydrogen and oxygen gas more rapidly.

The baffle structure 110 can be constructed from materials having specific properties to ensure optimal performance. The material can possess an acoustic impedance that is compatible with water to ensure efficient transmission of ultrasonic waves through the volume of water 104. Given the operating environment, the material can be resistant to water and other chemicals it may encounter during the hydrogen and oxygen gas generation process. The material can maintain its structural integrity and performance characteristics over a wide range of operating conditions, including temperature variations and continuous ultrasonic vibration. Additionally, the material can be chemically inert with water and the gases produced during electrolysis.

The baffle structure 110 can include one or more mechanisms, structures, and/or devices configured to increase and/or decrease ultrasonic wave motion. Examples of such baffle structures can include rubber sheeting, a rubber piece of material, or other similar devices known to those of skill in the art to be capable of increasing/disrupting the ultrasonic wave patterns. The baffle structure 110 can include various rubber materials. For example, the baffle structure 110 can be formed from ethylene propylene diene monomer (EPDM) rubber sheeting with a thickness of 0.5 inch. The rubber material can provide the necessary acoustic impedance compatibility while maintaining chemical resistance and durability under continuous ultrasonic vibration.

A gas collection unit 114 can be positioned on or near a top portion of the vessel 102 and can be in fluid communication with the vessel 102. The gas collection unit 114 can be configured to collect, separate, and store the hydrogen and oxygen gases that are generated within the vessel 102 during operation. The gas collection unit 114 can be configured to facilitate the transfer of the collected and separated gases to downstream operations. The gas collection unit 114 can include separate output conduit lines for hydrogen and oxygen gases, enabling the controlled distribution of these gases for various applications.

In certain embodiments, the gas collection unit 114 can include separate collection chambers that can be specifically configured to collect and store different gases based on their generation sites within the vessel 102. A first chamber 116 of the gas collection unit 114 can be configured to collect and store hydrogen gas from the cathodes of the electrodes 106, while a second chamber 118 can be configured to collect and store oxygen gas from the anodes of the electrodes 106.

The gas collection unit 114 can include a series of conduit lines (not shown) configured to transport the separated gases from the respective collection sites at the electrodes 106 to the designated storage chambers 116, 118. The gas collection unit 114 can incorporate valves (not shown) positioned along these conduit lines to control gas flow. Additionally, the gas collection unit 114 can include flame arrestors configured to militate gases from flowing back into the vessel 102.

The hydrogen and oxygen gas generation system 100 can include a power source 120 configured to supply power to the electrodes 106. The power source 120 can include a battery unit configured to provide direct current to the electrodes. In certain embodiments configured for vehicular applications, the hydrogen and oxygen gas generation system 100 can include a secondary power generation system. The secondary power generation system can include an alternator-generator configured to generate electricity from rotating components of a vehicle drive train.

The hydrogen and oxygen gas generation system 100 can include a water supply system 122 configured to maintain water levels within the vessel 102. The water supply system 122 can be configured to replenish the volume of water 104 as needed during operation. The water supply system 122 can be configured to supply tap water without requiring electrolytes or other additives to enhance conductivity. The water supply system 122 can include monitoring mechanisms configured to track water levels and initiate replenishment when needed. The water supply system 122 can be configured to work in conjunction with the pressure management system and safety gauges to ensure proper operating conditions are maintained during water replenishment. The water supply system 122 can include valves and control mechanisms configured to regulate water flow into the vessel 102.

The gas collection unit 114 can incorporate various safety features to ensure proper operation. For example, the gas collection unit 114 can include a hydrogen detection sensor that can be configured to monitor hydrogen levels and provide an alarm signal when hydrogen generation reaches a predetermined high level. The gas collection unit 114 can also include a safety gauge that can be configured to monitor pressure within the collection chambers and release excess pressure as needed to maintain safe operating conditions. The hydrogen and oxygen gas generation system 100 can include monitoring systems configured to track operational parameters. The monitoring systems can include sensors for monitoring water levels, gas production rates, and electrical current flow.

The hydrogen and oxygen gas generation system 100 can be scaled to larger configurations. In certain embodiments, multiple individual systems 100 can be connected together, with each system having a vessel 102, electrodes 106, ultrasonic unit 108, and baffle structure 110. Alternatively, the hydrogen and oxygen gas generation system 100 can be configured as a single large vessel containing multiple components. When configured with multiple individual systems 100, each system can operate independently to generate hydrogen and oxygen gases through the combined effects of electrolysis and ultrasonic wave generation. The multiple systems can share a centralized power source 120 configured to supply electrical current to all electrodes 106. A centralized water supply system 122 can be configured to maintain proper water levels within each vessel 102.

In certain embodiments, the system can be configured as a single large vessel 102 containing multiple ultrasonic units 108 positioned along the bottom portion of the vessel. Multiple pairs of electrodes 106 can be distributed throughout the volume of water above the ultrasonic units 108, with each pair including a cathode configured to collect hydrogen gas and an anode configured to collect oxygen gas. A single large baffle structure 110 can be positioned between the array of ultrasonic units 108 and the electrode pairs 106.

These scaled configurations can be particularly suitable for various applications. For example, the hydrogen and oxygen gas generation system 100 can be configured as a hydrogen generation station similar to a gas station, generating hydrogen and oxygen gases on demand for fueling hydrogen-powered vehicles without requiring storage tanks. The hydrogen and oxygen gas generation system 100 can also be configured as an in-vehicle hydrogen generation plant. In vehicular applications, the hydrogen and oxygen gas generation system 100 can include a secondary power generation system with an alternator-generator that generates electricity from rotating components of the vehicle drive train. The generated voltage can be used directly by the hydrogen generation system or stored in a battery bank that is continuously charged when the vehicle is in motion. The generated hydrogen and oxygen gases can be used as the sole fuel source for an internal combustion engine or in hybrid configurations, such as hybrid gasoline-hydrogen or hybrid gasoline-hydrogen-oxygen engines. For stationary applications like hydrogen fueling stations, either the multiple-unit configuration or the single large vessel configuration can be used to meet higher volume production requirements. These configurations can include appropriately scaled centralized power sources, water supply systems, and gas collection units for commercial fueling operations.

### Experimental

The following example illustrates a test conducted on an exemplary system constructed in accordance with the description provided herein.

The test stand included specific components and parameters for evaluating hydrogen generation performance. The hydrogen and oxygen gas generation system 100 utilized an electrical power input of 6V DC 10A. The vessel had a total capacity of 4.30 liters and contained 2.46 liters of tap water solution with a sodium bicarbonate catalyst. The hydrogen and oxygen gas generation system 100 included a top water-filled ultrasonic chamber with 1.62 liters filled volume and a total chamber capacity of 7.08 liters. A 1 liter flow test column had a total capacity of 1.99 liters with a water-filled volume of 0.72 liters. The electrodes were constructed of 304 stainless steel in a 6 blade configuration, and the baffle structure consisted of an EPDM rubber sheet with 1 inch clearance around the perimeter.

The theory behind this experiment suggests that increased hydrogen and oxygen gas production is possible when electrodes are impacted by disrupted ultrasonic waves. Without the baffle structure, ultrasonic waves maintain a vertical motion. However, with the introduction of the baffle structure, the ultrasonic waves bounce around the outer perimeter, causing them to impact the electrodes from the side. This side impact disrupts the hydrogen and oxygen molecules and allows them to separate for a longer period, resulting in more rapid gas production.

Three distinct tests were conducted, with each test performed in three cycles to obtain averaged results. The first test utilized applied power only, the second test combined applied power with ultrasonic waves, and the third test incorporated applied power with both ultrasonic waves and heat. The first test, using applied power only, resulted in an average of 314 seconds to produce 1 liter of hydrogen. Individual cycle times were 314, 316, and 312 seconds respectively. The second test, combining power with ultrasonic waves, demonstrated superior performance with an average of 246 seconds to produce 1 liter of hydrogen. The cycle times for this test were 249, 246, and 244 seconds. The third test, which added heat to the power and ultrasonic wave combination, showed slightly decreased efficiency with an average of 252 seconds to produce 1 liter of hydrogen, with cycle times of 252, 251, and 254 seconds.

The results demonstrated that the combination of power and ultrasonic waves produced hydrogen 22% more effectively than power alone. The addition of heat slightly decreased this efficiency.

### Examples

Example embodiments of the present technology are provided with reference to the several figures enclosed herewith.

With reference to FIG. 1, a hydrogen and oxygen gas generation system 100 is shown. The hydrogen and oxygen gas generation system 100 includes a vessel 102 containing a volume of water 104, six electrodes 106 arranged in a straight blade configuration, an ultrasonic unit 108, and a baffle structure 110. The ultrasonic unit 108 can be positioned at a bottom portion of the vessel 102 in the volume of water 104. The baffle structure 110 can be positioned above and spaced apart from the ultrasonic unit 108. The eight electrodes 106 can be positioned above and spaced apart from the baffle structure 110. The electrodes 106 can include both cathodes and anodes configured to create an electrochemical gradient when electrical current is applied. The cathodes can collect hydrogen gas while the anodes can collect oxygen gas during operation. A gas collection unit 114 can be positioned at a top portion of the vessel 102. The gas collection unit 114 can include a first chamber 116 configured to collect and store hydrogen gas from the cathodes and a second chamber 118 configured to collect and store oxygen gas from the anodes. The baffle structure 110 can be positioned between the ultrasonic unit 108 and the electrodes 106 to militate against direct vertical impact of ultrasonic waves on the electrode surfaces while still allowing the waves to assist in weakening molecular bonds in the water.

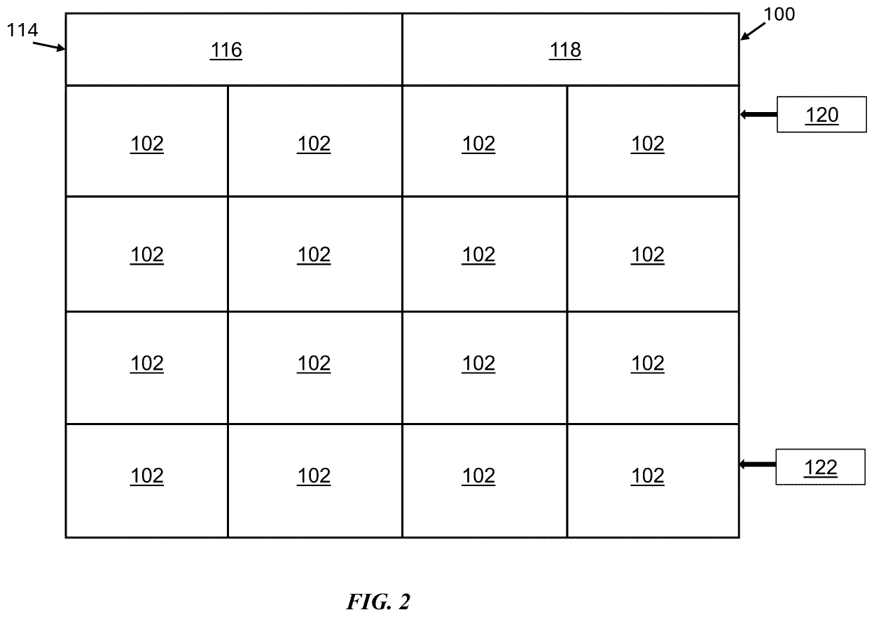

With reference to FIG. 2, a large-scale hydrogen and oxygen gas generation system 100 is shown. The hydrogen and oxygen gas generation system 100 can include multiple vessels 102, each vessel 102 effectively being a separate hydrogen and oxygen gas generation subsystem including the electrodes 106, the ultrasonic unit 108, and the baffle structure 110, as described for FIG. 1. Each vessel 102 can operate independently to generate hydrogen and oxygen gases through the combined effects of electrolysis and ultrasonic wave generation. The hydrogen gas can collect at the cathodes while oxygen gas can collect at the anodes of the electrodes 106 in each vessel 102.

The multiple vessels 102 can be connected to a centralized gas collection unit 114 through a network of conduit lines. The centralized gas collection unit 114 can be configured to collect, separate, and store the combined hydrogen and oxygen gas output from all connected systems. The centralized gas collection unit 114 can include larger collection chambers specifically configured to accommodate the increased gas volume from multiple systems. A first chamber 116 can be configured to collect and store the combined hydrogen gas output from the cathodes of all systems, while a second chamber 118 can be configured to collect and store the combined oxygen gas output from the anodes. The power source 120 can be configured to supply power to the electrodes 106 of each individual system 100. The water supply system 122 can be configured to maintain water levels within each vessel 102. The water supply system 122 can be configured to replenish the volume of water 104 as needed during operation.

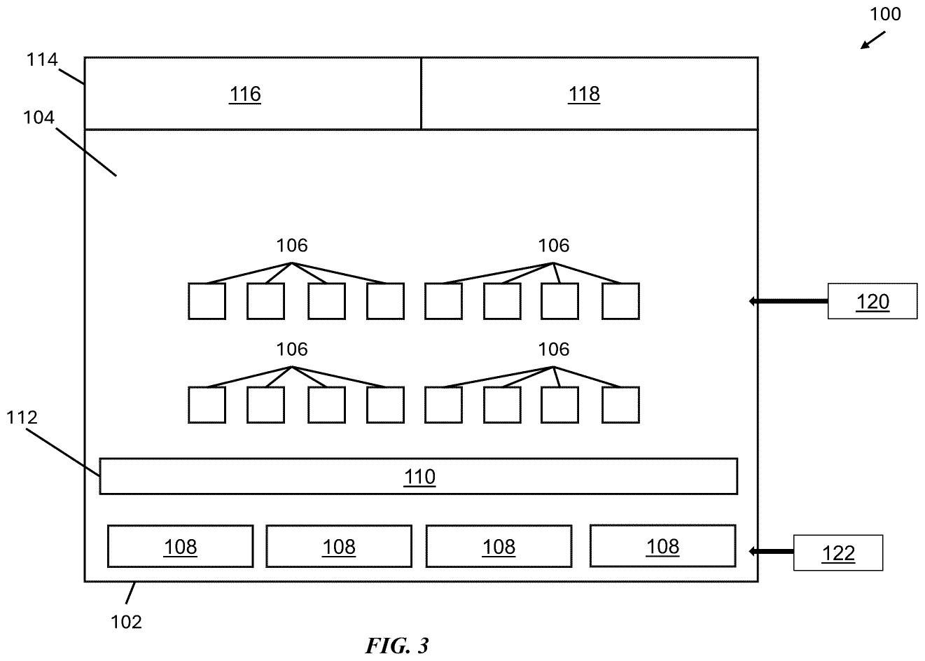

With reference to FIG. 3, a large-scale hydrogen and oxygen gas generation system 100 is shown. The hydrogen and oxygen gas generation system 100 can include a single large vessel 102 containing a volume of water, with multiple ultrasonic units 108 positioned along the bottom portion of the vessel 102. The hydrogen and oxygen gas generation system 100 can include multiple pairs of electrodes 106 distributed throughout the volume of water above the ultrasonic units 108. Each pair can include a cathode configured to collect hydrogen gas and an anode configured to collect oxygen gas. The electrodes 106 can be arranged to create an effective electrochemical gradient when DC current is applied.

A baffle structure 110 can be positioned between the array of ultrasonic units 108 and the electrode pairs 106. The baffle structure 110 can be configured to prevent direct vertical impact of ultrasonic waves on the electrode surfaces while still allowing the waves to assist in weakening molecular bonds in the water. The baffle structure 110 can be sized to correspond to the larger vessel dimensions while maintaining proper clearance for wave propagation. The multiple ultrasonic units 108 can be configured to emit sonic waves simultaneously, creating enhanced molecular stress throughout the larger volume of water. The waves can be emitted as square waves and can be varied in frequency and timing to optimize gas generation across the larger system.

A gas collection unit 114 can be positioned at the top portion of the vessel. The gas collection unit 114 can include a first chamber 116 configured to collect and store the combined hydrogen gas output from all cathodes and a second chamber 118 configured to collect and store the combined oxygen gas output from all anodes. The hydrogen and oxygen gas generation system 100 can include a centralized power source 120 configured to supply electrical current to all electrode pairs and ultrasonic units, and a water supply system 122 configured to maintain proper water levels within the large vessel.

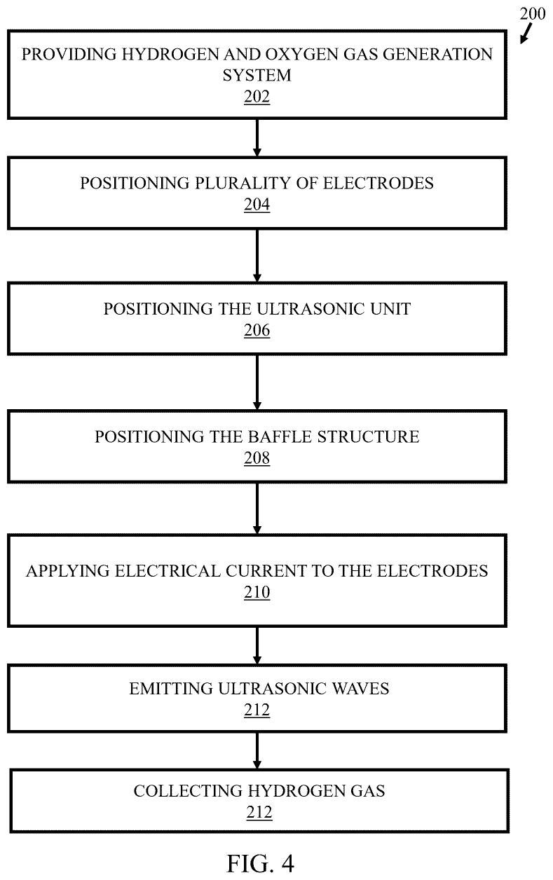

With reference to FIG. 4, a method 200 for generating hydrogen gas is shown.

The method 200 can include a step 202 of providing a hydrogen and oxygen gas generation system 100 having a vessel 102 containing a volume of water 104, a plurality of electrodes 106, an ultrasonic unit 108, and a baffle structure 110. The method 200 can include a step 204 of positioning the plurality of electrodes 106 in the volume of water 104. The electrodes 106 can include both cathodes and anodes configured to create an electrochemical gradient when electrical current is applied. The method 200 can include a step 206 of positioning the ultrasonic unit 108 in the volume of water 104. The ultrasonic unit 108 can be configured to emit sonic waves, preferably in the form of square waves, that inject pulsed energy into the volume of water 104. The method 200 can include a step 208 of positioning the baffle structure 110 between the plurality of electrodes 106 and the ultrasonic unit 108. The baffle structure 110 can be configured to prevent direct vertical impact of sonic waves on the electrodes 106 while allowing the waves to assist in weakening molecular bonds in the water.

The method 200 can include a step 210 of applying electrical current to the electrodes 106 to create an electrochemical gradient in the volume of water 104. The electrical current can polarize the water molecules and put stress on the molecular bonds. The method 200 can include a step 212 of simultaneously emitting ultrasonic waves from the ultrasonic unit 108 while the electrical current is applied. The ultrasonic waves can cause the water molecules to resonate and create additional stress on the molecular bonds. The waves can be redirected by the baffle structure 110 to impact the electrodes 106 from the side rather than vertically.

The method 200 can include a step 214 of collecting hydrogen gas at the cathodes and oxygen gas at the anodes as the water molecules break down under the combined stress of the electrical current and ultrasonic waves. The method 200 can include a step 216 of directing the collected gases through separate conduit lines to a gas collection unit 114. The gas collection unit 114 can separate and store the hydrogen gas in a first chamber 116 and the oxygen gas in a second chamber 118.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system configured to generate hydrogen and oxygen gas from water, comprising:
a vessel configured to contain the water;
a plurality of electrically conductive electrodes positioned in the vessel to contact the water;
an ultrasonic unit positioned in the vessel, the ultrasonic unit configured to emit sonic waves into the water;
a baffle structure positioned in the vessel between the plurality of electrically conductive electrodes and the ultrasonic unit.

2. The hydrogen and oxygen gas generation system of claim 1, wherein the baffle structure includes a clearance around an outer perimeter of the baffle structure and the vessel to allow ultrasonic waves to bounce around the baffle structure.

3. The hydrogen and oxygen gas generation system of claim 1, wherein the baffle structure includes a rubber material.

4. The hydrogen and oxygen gas generation system of claim 3, wherein the rubber material is EPDM rubber.

5. The hydrogen and oxygen gas generation system of claim 1, wherein the ultrasonic unit is configured to vary a frequency of the sonic waves during operation.

6. The hydrogen and oxygen gas generation system of claim 1, further comprising a gas collection unit in fluid communication with the vessel.

7. The hydrogen and oxygen gas generation system of claim 6, wherein the gas collection unit includes a first chamber configured to collect hydrogen gas and a second chamber configured to collect oxygen gas.

8. The hydrogen and oxygen gas generation system of claim 1, further comprising a water supply system configured to maintain a water level within the vessel.

9. The hydrogen and oxygen gas generation system of claim 1, wherein the ultrasonic unit is positioned proximate to a bottom portion of the vessel.

10. A hydrogen and oxygen gas generation system comprising a plurality of individual systems configured to generate hydrogen and oxygen gas from water according to claim 1.

11. The hydrogen and oxygen gas generation system of claim 10, further comprising a centralized power source configured to supply electrical current to the electrodes of each individual system.

12. The hydrogen and oxygen gas generation system of claim 10, further comprising a centralized water supply system configured to maintain a water level within each vessel.

13. The hydrogen and oxygen gas generation system of claim 10, further comprising a centralized gas collection unit configured to collect hydrogen and oxygen gases from each individual system.

14. The hydrogen and oxygen gas generation system of claim 1, wherein:
the ultrasonic unit comprises a plurality of ultrasonic units positioned along a bottom portion of the vessel;
the plurality of electrically conductive electrodes comprises a plurality of electrode pairs distributed throughout the volume of water above the ultrasonic units, each pair comprising a cathode configured to collect hydrogen gas and an anode configured to collect oxygen gas; and
the baffle structure is positioned between the plurality of ultrasonic units and the plurality of electrode pairs.

15. The hydrogen and oxygen gas generation system of claim 1, further comprising a gas collection unit positioned at a top portion of the vessel, the gas collection unit including a first chamber configured to collect hydrogen gas and a second chamber configured to collect oxygen gas.

16. The system of claim 14, wherein the plurality of ultrasonic units is configured to simultaneously emit sonic waves.

17. The system of claim 14, wherein the plurality of ultrasonic units is configured to emit sonic waves in a predetermined pattern.

18. A method of generating hydrogen and oxygen gases comprising:
providing a vessel and filling the vessel with a volume of water;
positioning a plurality of electrically conductive electrodes in the volume of water;
positioning an ultrasonic unit in the volume of water;
positioning a baffle structure between the plurality of electrically conductive electrodes and the ultrasonic unit;
applying electrical current to the plurality of electrically conductive electrodes to create an electrochemical gradient in the volume of water;
emitting sonic waves from the ultrasonic unit into the volume of water; and
collecting hydrogen gas at cathodes of the plurality of electrically conductive electrodes and oxygen gas at anodes of the plurality of electrically conductive electrodes.

19. The method of claim 18, further comprising:
directing the collected hydrogen and oxygen gases through separate conduit lines to a gas collection unit; and
storing the collected hydrogen gas in a first chamber of the gas collection unit and storing the collected oxygen gas in a second chamber of the gas collection unit.

20. The method of claim 18, further comprising a centralized water supply system configured to maintain a water level within the vessel.
